(19) United States
(12) Patent Application Publication
(10) Pub. No.: US 2003/0222398 A1
(43) Pub. Date: Dec. 4, 2003

(54) Illumination of a coin tray of a gaming machine

(76) Inventors: Gregory J. Tastad, Kenosha, WI (US); Norman R. Wurz, Des Plaines, IL (US)

Correspondence Address: Michael J. Blankstein, WMS Gaming Inc., 800 South Northpoint Blvd., Waukegen, IL, 60085, US

(21) Appl. No.: 10/160,414

(22) Filed: May 31, 2002

(51) Int. Cl. G07F 17/34

(52) U.S. Cl. 273/148 R

(57) ABSTRACT

A gaming machine comprises a display area, a coin tray, a lighting element, and a light amplification element. The display area supporting an artwork panel. The coin tray is proximate to the display area. When the lighting element is switched on, it illuminates the artwork panel and the coin tray. The light amplification element, which is preferably a lens with angular facets, amplifies and directs light from the lighting element toward the coin tray to enhance the illumination of the coin tray.

### FIELD OF THE INVENTION

The present invention relates generally to gaming machines and, more particularly, to a method and arrangement for illuminating a coin tray of a gaming machine.

### BACKGROUND OF THE INVENTION

Gaming machines typically include a lower frontal display area and a coin tray mounted to a machine housing below the display area. The display area may hold a glass artwork panel (or “belly” glass) depicting colorful graphics and/or information such as a game name, minimum wager, pay table, etc. To draw attention to the display area, the artwork panel is illuminated by a fluorescent light bulb mounted behind the panel. In response to a player's election to redeem any credits remaining on the machine's credit meter, an interior coin hopper dispenses a corresponding number of coins into the coin tray. The player manually scoops the coins in the coin tray into a coin collection cup provided by the gaming establishment.

The coin tray generally relies upon ambient light or non-amplified, indirect light from the aforementioned fluorescent light bulb for illumination. Such light, however, is generally insufficient to fully illuminate the coin tray. To make matters worse, things such as the gaming machine itself, the player, and a stool situated in front of the gaming machine may prevent ambient light from even reaching the coin tray and thereby cast shadows that darken portions of the coin tray. Due to poor visibility, the player may take longer to locate and collect coins in the coin tray and may even inadvertently miss some of the coins.

### SUMMARY OF THE INVENTION

To overcome the above-noted drawbacks, the present invention provides a gaming machine comprising a display area, a coin tray, a lighting element, and a light amplification element. The display area supporting an artwork panel. The coin tray is proximate to the display area. When the lighting element is switched on, it illuminates the artwork panel and the coin tray. The light amplification element, which is preferably lens with angular facets, amplifies and directs light from the lighting element toward he coin tray to enhance the illumination of the coin tray.

### BRIEF DESCRIPTION OF THE DRAWINGS

The foregoing and other advantages of the invention will become apparent upon reading the following detailed description and upon reference to the drawings.

FIG. 1 is an isometric view of a gaming machine including an arrangement for illuminating a coin tray in accordance with the present invention.

FIG. 2 is an enlarged isometric view of a lower portion of the gaming machine.

FIG. 3 is a sectional view taken generally along line 3-3 in FIG. 2.

FIG. 4 is a sectional view of a lens with angular facets employed in the arrangement for illuminating the coin tray.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENT

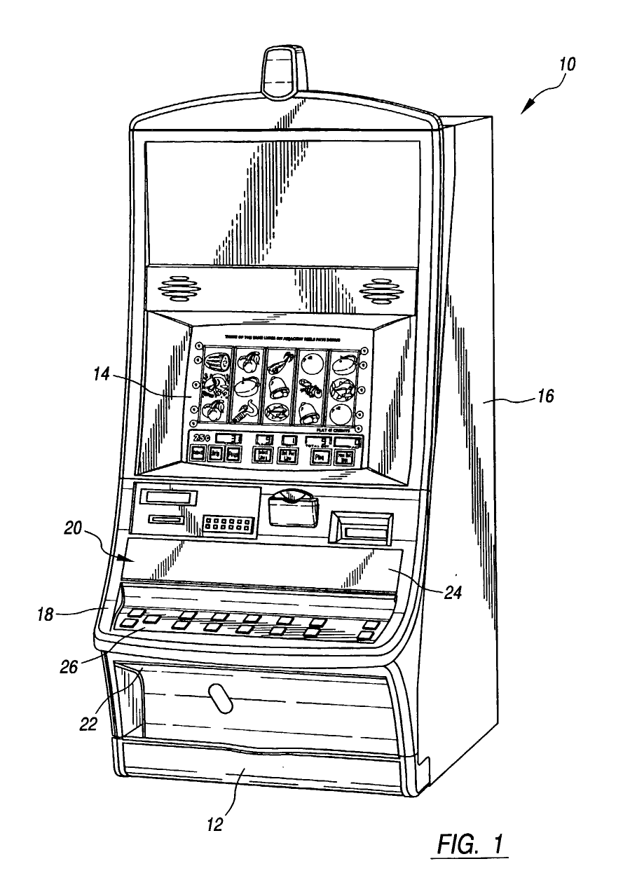

Referring now to the drawings, FIG. 1 depicts a gaming machine 10 including a cost-effective arrangement for illuminating a coin tray 12 in accordance with the present invention. The gaming machine 10 is operable to play a game of chance such as mechanical or video slots, poker, blackjack, keno, or bingo. In response to a wager, a central processing unit (CPU) randomly selects a game outcome from a plurality of possible outcomes and visually represents the selected outcome on a display such as a video display 14. If the selected outcome corresponds to a winning outcome, the player is awarded a payout identified on a pay table for that winning outcome.

The gaming machine 10 includes a cabinet 16 and a lower front door 18 hinged to the cabinet 16. The front door 18 includes a display area 20 and a generally flat wall 22 between the display area 20 and the coin tray 12. The coin tray 12 is mounted to a lowermost end of the cabinet 16 such that the coin tray 12 is below the display area 20. The display area 20 supports an artwork panel 24 preferably composed of glass imprinted with artwork using a digital imaging or screen printing process. The artwork may include colorful graphics and/or information such as a game name, minimum wager (coin denomination), pay table, etc. The door 18 also includes a button panel 26 for operating the gaming machine 10. The button panel 26 is preferably below the display area 20 and above the wall 22, but may alternatively be above both the display area 20 and the wall 22.

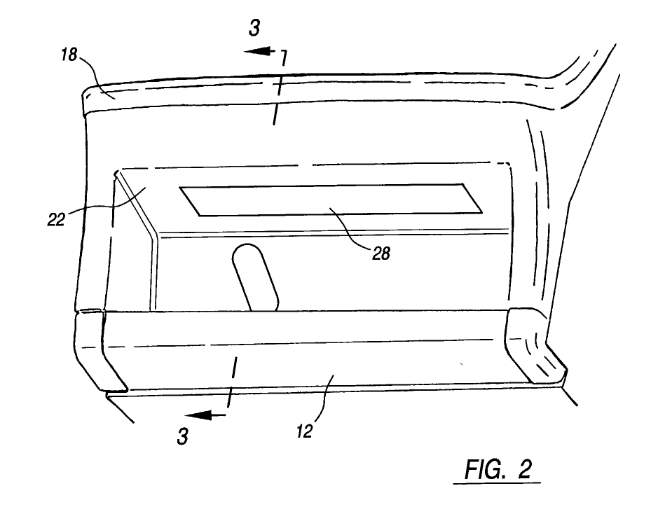

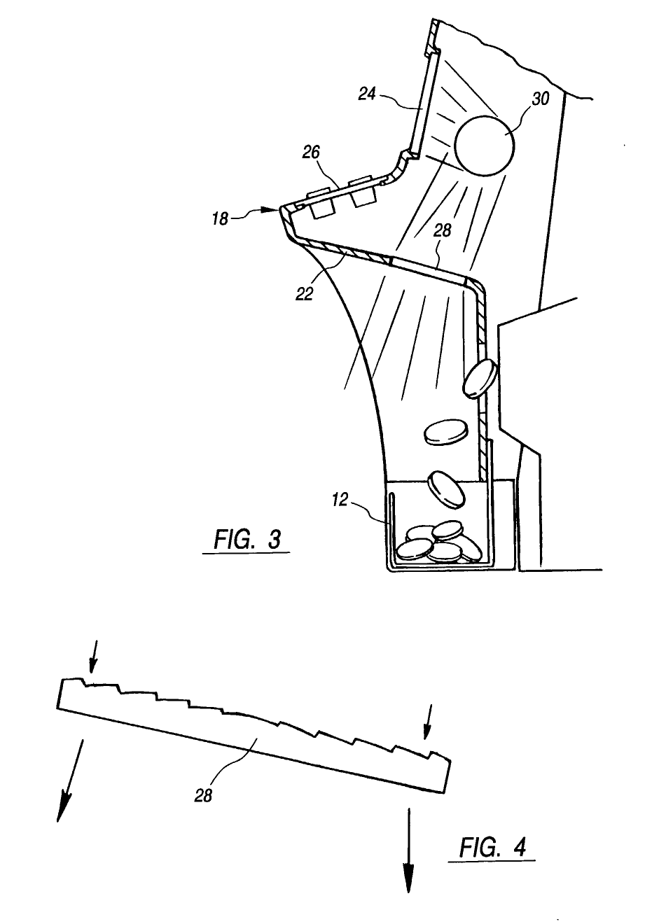

In accordance with the present invention, the gaming machine includes a cost-effective arrangement for enhancing illumination of the coin tray 12. This arrangement is lo best shown in FIGS. 2 and 3. Specifically, the wall 22 includes an elongated window containing a light amplification element 28 such as a lens with angular facets or a Fresnel lens. A Fresnel lens is a thin optical lens consisting of concentric rings of segmental lenses and having a short focal length. FIG. 4 depicts a cross-section of the lens 28. Referring back to FIGS. 2 and 3, the lens 28 is preferably centered between the right and left sides of the front door 18 (see FIG. 2) and spans approximately one-half or more of the length of the coin tray 12. In one embodiment, the coin tray 12 has a length of about 21 inches, and the lens 28 has a length of about 10 inches and a width of about 1.5 inches. The length of the lens 28 relative to the coin tray 12 may, however, be varied. For example, to illuminate only a specific area of the coin tray 12, the length of the lens 28 would be reduced to focus on that area.

A lighting element 30, such as a fluorescent light bulb, is mounted above the wall 22 and preferably behind the artwork panel 24. To uniformly illuminate the artwork panel 24, the lighting element 30 preferably extends along most of the length of the artwork panel 24. When the lighting element 30 is switched on, it illuminates both the artwork panel 24 and the coin tray 12. The lens 28 bends and amplifies the light from the lighting element 30 as the light passes therethrough. Due to improved visibility of the illuminated coin tray 12, the player can easily locate and collect coins in the coin tray 12.

While the present invention has been described with reference to one or more particular embodiments, those skilled in the art will recognize that many changes may be made thereto without departing from the spirit and scope of the present invention. For example, the lens 28 may be replaced with a curved mirror arrangement for amplifying and directing light from the lighting element 30 toward the coin tray 12. Each of these embodiments and obvious variations thereof is contemplated as falling within the spirit and scope of the claimed invention, which is set forth in the following claims:

What is claimed is:

1. A gaming machine, comprising:
a display area supporting an artwork panel;
a coin tray proximate to the display area;
a lighting element for illuminating the artwork panel and the coin tray; and
a light amplification element for amplifying and directing light from the lighting element toward the coin tray.

2. The gaming machine of claim 1, wherein the light amplification element includes a lens.

3. The gaming machine of claim 2, wherein the lens has angular facets.

4. The gaming machine of claim 1, wherein the light amplification element is elongated and spans approximately one-half or more of a length of the coin tray.

5. The gaming machine of claim 1, wherein the lighting element includes a fluorescent light bulb.

6. The gaming machine of claim 1, further including a button panel for operating the gaming machine, the display area being located above the button panel.

7. The gaming machine of claim 1, wherein the lighting element is mounted behind the artwork panel.

8. The gaming machine of claim 1, wherein the coin tray is below the display area, and the light amplification element is mounted between the coin tray and the display area.

9. A gaming machine controlled by a processor in response to a wager, comprising:
a button panel for operating the gaming machine;
a display area above the button panel and supporting an artwork panel;
a coin tray below the button panel;
a light amplification element mounted between the display area and the coin tray;
a lighting element for illuminating the artwork panel and the coin tray; and
a light amplification element for amplifying and directing light from the lighting element toward the coin tray, the light amplification element being mounted between the display area and the coin tray, the lighting element being mounted above the light amplification element.

10. The gaming machine of claim 9, wherein the light amplification element is between the button panel and the coin tray.

11. The gaming machine of claim 9, wherein the light amplification element includes a lens.

12. The gaming machine of claim 9, wherein the light amplification element is elongated and spans approximately one-half or more of a length of the coin tray.

13. The gaming machine of claim 9, wherein the lighting element includes a fluorescent light bulb.

14. The gaming machine of claim 9, wherein the lighting element is mounted behind the artwork panel.

15. A method of enhancing illumination of a coin tray in a gaming machine, the gaming machine including a display area and a coin tray, the display area supporting an artwork panel, the coin tray being proximate to the display area, the method comprising:
illuminating the artwork panel with a lighting element; and
amplifying and directing light from the lighting element toward the coin tray.

16. The method of claim 15, wherein the step of amplifying and directing light employs a light amplification element.

17. The method of claim 16, wherein the light amplification element includes a lens.

18. The method of claim 17, wherein the lens has angular facets.

19. The method of claim 16, wherein the light amplification element is elongated and spans approximately one-half or more of a length of the coin tray.

20. The method of claim 15, wherein the lighting element is mounted behind the artwork panel.
